(19) United States
(12) Patent Application Publication
(10) Pub. No.: US 2007/0005489 A1
(43) Pub. Date: Jan. 4, 2007

(54) METHOD FOR SELLING PRE-OWNED INTEGRATED CIRCUIT MANUFACTURING EQUIPMENT ONLINE

(75) Inventors: KOICHI USUI, Tokyo (JP); Tsutomu Tanaka, Tokyo (JP); Masanori Takahashi, Narita -Shi (JP); Kabita Das, Campbell, CA (US); Scott Ritterbush, Mountain View, CA (US); Kumar Ramachandran, Fremont, CA (US); Gary Robertson, Palo Alto, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/470,055

(22) Filed: Sep. 5, 2006

Related U.S. Application Data
(63) Continuation of application No. 09/921,255, filed on Aug. 1, 2001.

(51) Int. Cl. G06Q 40/00

(52) U.S. Cl. 705/37

(57) ABSTRACT

Embodiments of the invention provide a method for selling integrated circuit manufacturing systems online, wherein the method includes receiving information representing a integrated circuit manufacturing system available for purchase, posting the information on an electronically viewable medium, and receiving an electronically transmitted bid for the integrated circuit manufacturing system from a buyer. The method further includes transmitting the bid to a seller, receiving a bid acceptance from the seller, and providing technical services related to the integrated circuit manufacturing system available for purchase to at least one of the buyer and seller through an integrated online service.

### CROSS-REFERENCE TO RELATED APPLICATIONS

This application is a continuation of co-pending U.S. patent application Ser. No. 09/921,255, filed Aug. 1, 2001. The aforementioned related patent application is herein incorporated by reference.

### BACKGROUND OF THE INVENTION

1. Field of the Invention

The present invention generally relates to a method for selling pre-owned and/or used integrated circuit manufacturing equipment through an online medium.

2. Description of the Related Art

Recent advancements in computer related technologies have generally supported substantial growth in the semiconductor-related industries as a whole. In particular, the producers of integrated circuit manufacturing equipment have experienced notable growth as a result of technology advancements. This growth and its accompanying demand has assisted in the formation and development of various ancillary semiconductor equipment related businesses and markets.

For example, an increased demand for semiconductor chips and related products has resulted in the development of a strong secondary market for buying and selling pre-owned integrated circuit manufacturing equipment. Conventionally, this business and/or market has primarily revolved around an equipment broker acting as an intermediary between purchasers of pre-owned and/or used integrated circuit manufacturing systems and the respective sellers of the systems. The equipment broker typically operates to receive information about various pre-owned integrated circuit manufacturing systems that are available for purchase, disseminate technical and purchase related information to potential system purchasers, and negotiate/broker the sale of the system to the buyer. The broker may also assist in the delivery and payment arrangements between the buyer and seller of the respective systems.

Although the process of purchasing pre-owned integrated circuit manufacturing equipment through a broker is generally successful, the process of having a broker as an intermediary in the transaction also includes several disadvantages. For example, transactions utilizing a broker inherently include a substantial fee for compensating the broker, which reduces the profit margin for the sellers of equipment and increases the cost of the equipment to the purchaser, as the brokering fee is generally passed on to the purchaser in the purchase agreement. Additionally, the use of a broker may also operate to limit the number of possible purchasers, as brokers often cater to clients who are known to accept and/or pay the highest brokerage fees. Therefore, brokers often only disseminate system information to purchasers that they know will pay above average brokerage fees, which may reduce the exposure of the sellers system to numerous potential purchasers. Furthermore, equipment brokers often deal in the sale of numerous types/fields of equipment, and therefore, the brokers are typically not technically knowledgeable about the systems they are brokering. This lack of technical knowledge may result in purchasers receiving a system that does not meet their specific manufacturing needs or that does not function properly, as brokers generally do not possess sufficient technical proficiency in the semiconductor related technologies to assist the purchaser with the technical details of the system purchase. Additionally, as a result of the lack of technical proficiency, equipment brokers are generally not capable of inspecting an integrated circuit manufacturing system for proper physical characteristics prior to the purchaser contracting for the sale of the system. Further still, brokered transactions are inherently slow, as all of the interaction between the purchaser and the seller is generally required to take place through the broker.

Therefore, in view of the disadvantages of utilizing an equipment broker for the purchase of pre-owned and/or used semiconductor equipment, there is a need for a method for buying and selling pre-owned/used integrated circuit manufacturing equipment, wherein the method eliminates the use of conventional equipment brokers. Further, there is a need for a method for selling pre-owned and/or used integrated circuit manufacturing equipment in an online environment configured to mass distribute available system purchase information though an online and/or automated process. Further still, there is a need for a method for selling pre-owned/used integrated circuit manufacturing equipment, wherein the method includes provisions for having the pre-owned integrated circuit manufacturing system inspected and/or refurbished by one of sufficient technical proficiency in the integrated circuit manufacturing technologies.

### SUMMARY OF THE INVENTION

Embodiments of the invention generally provide a method for selling used integrated circuit manufacturing systems online, wherein the method includes receiving information representing a integrated circuit manufacturing system available for purchase, posting the information on an electronically viewable medium, and receiving an electronically transmitted bid for the integrated circuit manufacturing system from a buyer. The method further includes transmitting the bid to a seller, receiving a bid acceptance from the seller, and providing technical services related to the integrated circuit manufacturing system available for purchase to at least one of the buyer and seller through an integrated online service.

Embodiments of the invention further provide a method for selling used integrated circuit manufacturing equipment through an integrated electronic sales and technical service platform, wherein the method includes posting information regarding used or pre-owned integrated circuit manufacturing systems available for purchase on an Internet web site, and providing integrated technical services related to the sale of the used integrated circuit manufacturing systems through the Internet web site. The method further includes receiving an electronic purchase bid for a specific integrated circuit manufacturing system posted on the Internet web site, transmitting the electronic purchase bid to a seller of the specific integrated circuit manufacturing system, and receiving a purchase bid acceptance from the seller.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a diagram of an embodiment of the invention;

FIG. 2 illustrates an embodiment of a purchase process of the invention.

FIG. 3 illustrates an embodiment of a purchase finalization and delivery process of the invention.

### DETAILED DESCRIPTION OF THE PREFERRED EMBODIMENT

The present invention generally provides an interactive online medium for purchasing and selling pre-owned and/or used, hereinafter simply referred to as “pre-owned,” integrated circuit manufacturing equipment. The term integrated circuit, as used herein, generally includes electronic, electrical, and optical circuits. Such equipment comprises, but is not limited to, material deposition chambers and systems, material removal chambers and systems, mainframes, polishers, planarization equipment, wafer orientors, annealing chambers, and any other chambers, systems or platforms that are used to fabricate integrated circuits. The online interactive medium, which may be an Internet web site specifically directed to integrated circuit manufacturing equipment, for example, may provide sellers of pre-owned integrated circuit manufacturing equipment with a forum for electronically posting purchase related information. Buyers may then browse through the posted system information via connection to the Internet and choose a specific system for purchase. The buyer may then electronically transmit purchase information, i.e., a system bid, to the Internet web site, which may then be electronically transmitted to the seller of the system. The buyer and seller may then negotiate and finalize the terms of the purchase utilizing several financial and semiconductor specific technical options provided by the Internet web site.

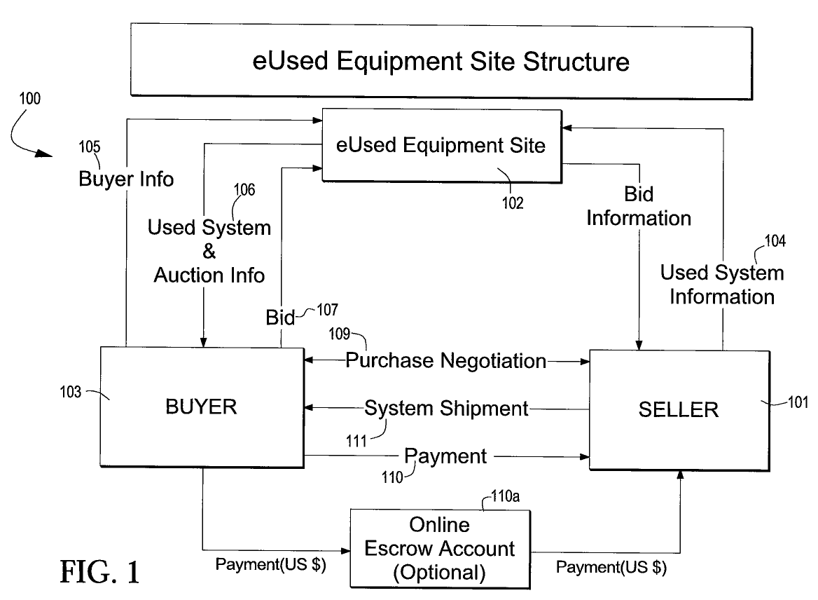

FIG. 1 illustrates a general diagram of one embodiment of the invention. The system for selling pre-owned integrated circuit manufacturing equipment 100 generally centers upon an interactive eUsed Equipment site 102, which may be an Internet web site, as is generally known in the art. Site 102 may be configured to receive sales information 104 from a seller of an integrated circuit manufacturing system 100. Sales information 104, which may generally represent the technical and financial information corresponding to the integrated circuit manufacturing system for sale, may be submitted through the seller 101 completing an online form designed to receive information specific to the particular system for sale. The system specific information contained within the online form may then be converted into a format suitable for posting and/or display on site 102. Buyers 103 may then view sales/auction information 106 pertaining to the integrated circuit manufacturing systems for sale by logging on site 102 and browsing through various system sales information 106 posted thereon. Buyers 103 may also submit buyer information 105, i.e., contact and billing information, to site 102 through an electronic form, which may then be used, for example, to generate a logon/security feature that may be used to access additional features of site 102. If buyer 103 locates an integrated circuit manufacturing system for purchase on site 102, then buyer 103 may electronically submit a bid form 107 to site 102. The bid form 107 may be received by site 102 and electronically transmitted to seller 101 for review and consideration. Seller 101 and buyer 103 may then negotiate the purchase terms 109 for the integrated circuit manufacturing system, either aside from site 102 or through the site 102. Payment arrangements 110, 110a and system shipment arrangements 111 may also be made between buyer 103 and seller 101. Payment arrangements may include and online escrow account (OEA) process, a cash-on-delivery process (COD), or other payment method calculated to afford security to both the buyer and seller in the transaction.

In another embodiment of the invention an online site similar to the site illustrated in FIG. 1 is provided for selling pre-owned integrated circuit manufacturing equipment. However, the online site may be hosted and/or associated with an integrated circuit manufacturing equipment-related individual and/or entity. The site host or associated entity may be, for example, a manufacturer of integrated circuit manufacturing equipment, such as Applied Materials of Santa Clara, Calif. In this embodiment, the site may therefore offer additional services to both buyers and sellers of integrated circuit manufacturing equipment as a result of the site host's technical expertise/proficiency with integrated circuit manufacturing equipment. For example, the site host may offer services in the nature of equipment inspection/auditing and verification. Equipment inspection and/or verification may be conducted, for example, at the time when the seller provides the equipment information to the web site. Alternatively, the buyer as a term or condition to the sale of the equipment may request that the equipment be subject to inspection/verification. In this situation, the equipment may be inspected for unusual wear, breakage, proper operational characteristics, contamination, safety compliance, falsely designated/forged equipment, and/or other conditions that may be of concern to a purchaser of pre-owned integrated circuit manufacturing equipment. This inspection/verification process may be conducted by experienced integrated circuit manufacturing equipment engineers or technicians, such as those that may be provided by Applied Materials, a prominent semiconductor equipment manufacturer.

In another embodiment of the invention an online site similar to the site illustrated in FIG. 1 may be provided wherein the site host is again an integrated circuit manufacturing equipment-related individual and/or entity, such as, for example, Applied Materials of Santa Clara, Calif. In this embodiment, the site may offer services in the nature of equipment refurbishment and/or repair through the above noted host or other entity having experience in the relevant technological field. Therefore, the buyer may require that the site host or qualified third party to refurbish the pre-owned integrated circuit manufacturing equipment to particular specifications as a term of the buyers acceptance of the equipment. In this embodiment, the site host or qualified third party may receive the pre-owned system from the seller, for example, via commercial shipping, and conduct the repairs/refurbishment tasks required to bring the system into compliance with the buyers specifications prior to the system being shipped to the buyer. Alternatively, if commercial shipment is not an option, for example, when the pre-owned system contains contaminants that prevent a commercial shipper from handling the system under federal or state regulations, then the site host or qualified third party may refurbish the system at the seller's premises. Thereafter, the refurbished system may be shipped or otherwise transferred to the buyer's preferred location. Regardless of the location of the refurbishment/repairs, the end result is that the buyer receives an integrated circuit manufacturing system that has been inspected and/or repaired by those who are known to be technologically proficient in the manufacture and repair of semiconductor related equipment.

In another embodiment of the invention the site host or third party may provide decontamination services to the buyer and seller of the pre-owned integrated circuit manufacturing system. These services may be critical to the terms and conditions of a sale of a pre-owned integrated circuit manufacturing system, as the raw materials utilized in the manufacture of semiconductor components often qualify as hazardous substances under federal and state regulations. Inasmuch as integrated circuit manufacturing systems regularly contain notable amounts of the raw materials within the system itself as a result of the manufacturing processes, i.e., sputtering, etching, and/or other deposition techniques regularly used in the manufacture of semiconductors, the transportation of pre-owned systems is typically prohibited by the state and federal hazardous materials regulations. Therefore, the host or other third party experienced in decontamination procedures may provide decontamination services at the equipment location so that the pre-owned system may then be shipped via commercial carrier to its final location. Alternatively, the pre-owned system may contain contaminants from previous manufacturing operations that do not prohibit the shipment of the system, but alternatively, may be known to conflict with the manufacturing operations intended by the buyer of the system. In this situation it is also necessary for the system to be decontaminated by persons experienced in integrated circuit manufacturing equipment decontamination procedures so that the buyer of the system will be able to manufacture the desired semiconductors without experiencing contamination resulting from residues remaining within the system. Therefore, the system may be shipped to a decontamination facility where qualified personnel may remove the residues. Thereafter, the system may be shipped to the buyers selected location for installation and subsequent manufacturing.

Regardless of the location of the refurbishment, audit/inspection, and/or decontamination services, embodiments of the invention provide the purchaser with an increased level of security in the purchase of a pre-owned integrated circuit manufacturing system. Inasmuch as pre-owned integrated circuit manufacturing systems regularly cost several hundred thousand dollars, the increased level of security for the purchasers is a significant advantage provided by the invention that conventional broker arrangements neglect to address. Furthermore, the invention provides the purchaser of pre-owned integrated circuit manufacturing equipment with a level of security in the quality of the system purchased, as experienced personnel may inspect and test the operation of the system prior to the buyer accepting the system from the seller for purchase. Additionally, the system may be decontaminated during the purchase process, rather than after the system is delivered to the buyer. This is advantageous, as if a system problem is discovered during the decontamination process, then the buyer may reject the purchase of the system, whereas in a broker arrangement the buyer generally has no method for determining the integrity of the system prior to delivery of the system after the purchase is final. Thus, the invention provides multiple levels of security to purchasers of pre-owned integrated circuit manufacturing equipment that are not available under conventional broker arrangements.

Another advantage provided by embodiments of the present invention is that purchasers of pre-owned integrated circuit manufacturing systems may save substantial expense through use of the invention. In particular, embodiments of the invention avoid nearly all of the brokerage fees associated with purchasing a system through an equipment broker, as the web site sales method has a substantially reduced cost in comparison to brokerage fees. For example, a semiconductor equipment refurbisher, such as Applied Materials of Santa Clara, Calif., may sponsor the web site as a means for generating refurbishment business through advertising/providing services on the web site. Therefore, in this situation the brokerage costs associated with selling a pre-owned system may be completely avoided, as the seller has no fees associated with advertising and selling a system.

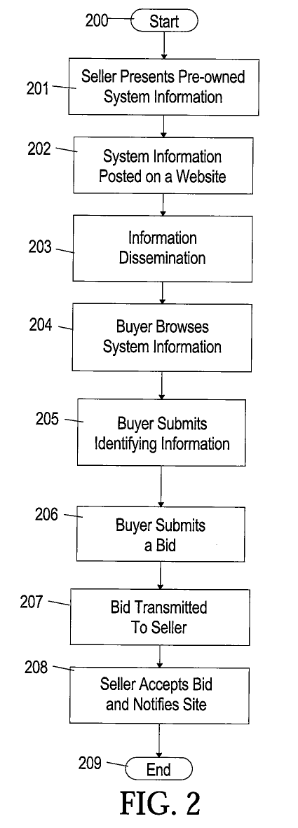

FIG. 2 illustrates an exemplary purchase method of an embodiment of the invention. The exemplary method begins at step 200 and continues to step 201 where a seller of a pre-owned integrated circuit manufacturing system submits information regarding the system to a host web site configured for selling integrated circuit manufacturing equipment. The submission of information may be through an online form completed by the seller, where the online form contains information pertaining to the physical and/or operational characteristics of the pre-owned system, as well as contact information for the seller. Additionally, the information may include electronic picture files illustrating the system, as well as other information that the seller desires to be viewed by potential purchasers of the system. Once the host web site receives this information, it may be converted into a form suitable for posting on the web site at step 202. At step 203 the web site may operate to disseminate information regarding the integrated circuit manufacturing system to known potential purchasers. For example, the host web site may maintain a database of potential purchasers, and this database may be used to inform potential purchasers of new systems being added to the web site for purchase. Additionally, the host web site may be configured to receive desired system preferences from potential purchasers, and then when a system meeting these desired system preferences is posted on the host web site, the host web site may send an electronic notification to the potential purchaser informing them that a system matching their requirements has been put up for sale on the host web site.

Once the information representing the pre-owned system has been posted on the host web site, potential purchasers may browse the information, as indicated by step 204. Users may enter search queries into the host web site database of systems for sale in order to display systems meeting various criteria desired by the users/potential purchasers. If a potential purchaser determines that a particular system listed on the host web site is of interest to the purchaser, then the potential purchaser may submit identifying information to the host web site at step 205. The identifying information may include contact information, financial information, information about the types of systems that the potential purchaser is interested in, time frames for acquiring specific systems, and/or other information relevant to the purchase of a pre-owned integrated circuit manufacturing system. This identifying information may then be used by the host web site to create a user specific account. The user specific account may require a secure logon to access the information in the account, as it is contemplated that the user specific account may contain information regarding pending bids, financial information relative to the user, and/or other information that the user may desire to remain out of the public domain. Additionally, the user information and user specific account may be used to verify the authenticity of the user when using the host web site, i.e., in order to avoid receiving false bids or information on the host web site.

Once a user's authenticity is verified by the host web site, i.e., once the user logs on to the host web site, the user may then submit a bid for a particular integrated circuit manufacturing system at step 206. The bid submission process may include the user filling out an online form having various integrated circuit manufacturing system related fields therein. Alternatively, the user may simply submit an electronic mail message to the host web site representing a bid for a system listed on the host web site. Once the bid is received by the host web site, regardless of the form that the bid is submitted in, then the bid may be submitted/transmitted to the seller of the particular system at step 207. The seller may receive the bid and review it for possible acceptance. If the seller accepts the bid, then the seller may electronically reply to the electronic bid notification at step 208. Alternatively, step 208 may also include the seller rejecting the current bid and responding to the host web site with an alternative bid in similar fashion to a contractual counter offer. Regardless of the sellers action in accepting or countering the buyers bid, the host web site is notified of the sellers action through an electronic communication, and may operate as an intermediary between the parties by forwarding subsequent offers/bids to the appropriate party until an agreement is reached. Thereafter, the purchase portion of the method ends at step 209.

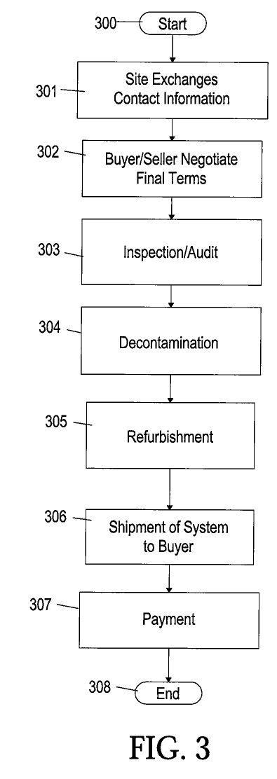

Once the bid information has been transmitted from the buyer to the seller and the seller has accepted the bid and notified the host web site of its acceptance, the exemplary method of the present invention continues to the purchase finalization and delivery process of the exemplary method, as illustrated in FIG. 3. The purchase finalization and delivery process illustrated in FIG. 3 begins with step 300 and continues to step 301, where the host web site exchanges contact information between the buyer and seller of the integrated circuit manufacturing system. For example, the host web site may electronically send contact information for each party to the other party, thus facilitating contact between the respective parties. Thereafter, at step 302 the buyer and seller may negotiate the final terms and conditions of the sale of the integrated circuit manufacturing equipment from the seller to the buyer, if necessary. Alternatively, these negotiations may take place through the web site. The final conditions may include, for example, the purchase price, additional items included in the purchase, warranty for system, delivery terms, return/refund terms, system condition upon delivery, temporal requirements for both parties, method of payment, and/or other terms and conditions that may be agreed upon my both parties. Once the final terms and conditions have been agreed upon by both parties and all of the supporting documentation has been transmitted between the respective parties, then the method continues to steps 303-305.

Steps 303-305 generally represent optional services that may be provided through the host web site administrator. As noted above, the embodiments of the invention contemplate that the host administrator of the host web site is an entity that is technically proficient in the semiconductor related arts, or alternatively, is an entity that is affiliated/associated with an entity having such qualifications. Therefore, the host web site administrator may provide services in the nature of system inspection/auditing, system decontamination, refurbishment, and/or other services that may be provided by one skilled in the semiconductor art in order to facilitate the sale of a pre-owned integrated circuit manufacturing system from a seller to a buyer. This arrangement facilitates a more efficient sale of pre-owned integrated circuit manufacturing systems, as the purchasers of these types of equipment do not have to purchase and take delivery of the respective system prior to having the system inspected, audited, decontaminated, and/or refurbished, as with conventional broker arrangements. Alternatively, embodiments of the invention provide the seller and buyer the option of using an intermediary in the sales transaction, wherein the intermediary is a party that is highly skilled in the integrated circuit manufacturing equipment technology. Therefore, the skilled intermediary party may provide technically related services to both parties to the transaction in order to facilitate the transaction. This is a significant improvement over conventional sales arrangements, as the buyer typically had to purchase and take possession of the system prior to conducting any refurbishment, repairs, and/or other modifications to the system. Therefore, since contractual arrangements for goods are typically fulfilled when payment is received by the seller and the goods are received and accepted by the buyer, buyers were often left only with litigious options for recovering from sellers once the systems were delivered.

Step 303 generally represents a system inspection and/or audit step. For example, as a condition to the purchase of the system, the buyer may require that the system pass an inspection and/or audit conducted by a third party skilled in the integrated circuit manufacturing equipment technology. In this situation, the web site host or an associated technically proficient party may be contracted to inspect and/or audit the system. The system may be commercially shipped to the inspecting party, or alternatively, the inspecting party may inspect the system at the seller's premises. In either situation, the system may be inspected as a term of the contractual arrangement between the buyer and seller. Furthermore, compensation for the inspecting party may also be incorporated into the contractual arrangement, which eliminates the buyers need for separately arranging for such services after the system is delivered in a conventional purchase arrangement through a broker.

Step 304 generally represents a system decontamination step. For example, if the integrated circuit manufacturing system has unwanted residues or other materials within the system as a result of previous integrated circuit manufacturing processes, then the buyer may require that the system be decontaminated prior to accepting the system for purchase. In similar fashion to the inspection/audit services, the decontamination process may be undertaken at the seller's place of business, or alternatively, if possible, the system may be shipped to a third party contracted to conduct decontamination procedures. In similar fashion to the inspection/audit process, the decontamination process may be a condition of sale for the purchaser of the integrated circuit manufacturing equipment. In fact, decontamination is a likely process associated with the sale of a pre-owned integrated circuit manufacturing system, as residues from previous manufacturing processes are commonly known to adversely affect other integrated circuit manufacturing processes. Therefore, a purchaser of integrated circuit manufacturing system is likely to require that the system be decontaminated of all previous manufacturing residues, as these materials will likely have a negative affect upon planned manufacturing processes.

Step 305 illustrates an additional service that may be provided by the host web site. In particular, step 305 illustrates that the buyer and seller of the pre-owned integrated circuit manufacturing system also have the option of selecting refurbishment of the system as an option to the purchase agreement. Inasmuch as various components of integrated circuit manufacturing equipment have a limited useful operational life, pre-owned systems will often require at least partial refurbishment in order to render the system operational for the purchaser of the system. Therefore, the host web site, or another party having the technical expertise and ability to undertake an integrated circuit manufacturing equipment refurbishment process, may be utilized to provide refurbishment services as a condition to the purchase agreement. Although refurbishment is generally a relatively costly process, purchasers of pre-owned systems often are able to purchase a pre-owned system and incur substantial refurbishment costs for much less than the cost of a new system. Therefore, refurbishment is generally an attractive process/option for purchasers of pre-owned integrated circuit manufacturing equipment. As such, the integration of refurbishment services into the sales method of the invention provides a substantially more efficient process for purchasers of integrated circuit manufacturing equipment to acquire suitable operational equipment at a reasonable cost and with minimal additional transaction overhead, i.e., without having to separately contract for refurbishment services.

Step 306 illustrates the shipment process of the present invention. For example, step 306 may represent the process of the buyer and seller arranging for a system to be shipped from the seller's location to either the buyer's location or a third parties location for one of the processes noted above in steps 303-305, or other technically related service. Step 307 generally represents the payment process of the invention. For example, as illustrated in FIG. 1, the invention may utilize an OEA for payment of the purchase. In this situation the buyer may deposit sufficient funds with an online escrow provider, who will transfer the appropriate funds to the appropriate parties upon completion of predetermined contractual/purchase conditions. Alternatives to OEA processes include cash on delivery services, credit-based purchases, financing arrangements, and/or other known methods for payment of goods and services, and in particular, goods and services purchased online. Once the payment process is complete at step 307, the method continues to step 308 where the method ends.

Although embodiments of the invention provide several advantages over conventional equipment purchase methods, a notable advantage is that the invention provides an integrated platform for purchasing integrated circuit manufacturing equipment. The integrated platform may provide equipment purchase related services, in addition to various ancillary technically orientated services. This is a result of the association of a technically proficient entity with the host web site, which allows the host web site to offer additional technically related services in single platform. As noted above, these services may include system inspection/audit, decontamination, refurbishment, and/or other technically related services that may be associated with rendering a pre-owned integrated circuit manufacturing system operation for a new purchaser of the system. As a result of this integration, purchasers are not required to secure additional services outside of the system purchase agreement, and further, the purchaser may pay a single amount to a single entity to cover both the system purchase and any technically related services offered by the host web site. As such, the complexity and overhead time associated with system purchases may be substantially reduced for both purchasers and sellers. Furthermore, the invention provides the capability to allow for various links to be inserted into the web content. For example, links to various financing institutions and companies may be provided in order to assist buyers in procuring payment arrangements.

While the foregoing detailed description is directed to exemplary embodiments of the invention, additional and further embodiments of the invention may be devised without departing from the basic scope thereof, wherein the scope is determined by the following claims.

1. A method for selling pre-owned integrated circuit manufacturing systems online, comprising:
receiving information representing an integrated circuit manufacturing system available for purchase;
posting the information on an electronically viewable medium, wherein the information is posted by a site host;
receiving an electronically transmitted bid for the integrated circuit manufacturing system from a buyer;
transmitting the bid to a seller;
receiving a bid acceptance from the seller; and
providing technical services related to the integrated circuit manufacturing system available for purchase to at least one of the buyer and seller through an integrated online service, wherein providing technical services comprises at least one of providing system inspection services, providing system audit services, providing system decontamination services, and providing system refurbishment services, and wherein the technical services are provided by the site host.

2. The method of claim 1, wherein the site host is a manufacturer of integrated circuit manufacturing equipment.

3. The method of claim 1, wherein the integrated circuit manufacturing system is selected from the group consisting of material deposition chambers and systems, material removal chambers and systems, mainframes, polishers, planarization equipment, wafer orientors, and annealing chambers.

4. The method of claim 1, wherein the buyer pays a single entity for both the integrated circuit manufacturing system and the technical services.

5. The method of claim 1, wherein posting the information comprises posting information representative of the integrated circuit manufacturing system available for purchase on an Internet web site of the site host.

6. The method of claim 1, wherein posting the information comprises electronically disseminating information regarding the integrated circuit manufacturing system available for purchase to targeted potential buyers.

7. The method of claim 1, wherein receiving an electronically transmitted bid comprises receiving an electronic bid message in a semiconductor equipment sales web site of the site host.

8. The method of claim 1, further comprising providing payment and shipping arrangements between the buyer and seller.

9. The method of claim 8, wherein the payment arrangements comprise at least one of an online escrow account arrangement, a cash on delivery arrangement, a credit arrangement, and a billable account set up with a site host web site.

10. The method of claim 1, further comprising receiving identification information from buyers and sellers, the identification information being calculated to facilitate secure access to the electronically viewable medium.

11. A method for selling used integrated circuit manufacturing equipment through an integrated electronic sales and technical service platform, comprising:
posting information regarding pre-owned integrated circuit manufacturing systems available for purchase on an Internet web site, wherein the information is posted by a site host;
providing integrated technical services from the site host through the Internet web site that are related to the sale of the pre-owned integrated circuit manufacturing systems, wherein providing integrated technical services comprises at least one of providing system inspection services, providing system audit services, providing system decontamination services, and providing system refurbishment services;
receiving an electronic purchase bid for a specific pre-owned integrated circuit manufacturing system posted on the Internet web site;
transmitting the electronic purchase bid to a seller of the specific pre-owned integrated circuit manufacturing system; and
receiving a purchase bid acceptance from the seller.

12. The method of claim 11, wherein the site host is a manufacturer of integrated circuit manufacturing equipment.

13. The method of claim 11, wherein the pre-owned integrated circuit manufacturing systems are selected from the group consisting of material deposition chambers and systems, material removal chambers and systems, mainframes, polishers, planarization equipment, wafer orientors, and annealing chambers.

14. The method of claim 11, wherein the integrated technical services are provided for the specific pre-owned integrated circuit manufacturing system before the specific pre-owned integrated circuit manufacturing system is shipped to a buyer.

15. The method of claim 11, wherein posting information comprises:
electronically receiving information regarding a pre-owned integrated circuit manufacturing system available for purchase from a seller;
converting the electronically received information into a format suitable for display on the Internet web site; and
displaying information representative of the pre-owned integrated circuit manufacturing system available for purchase on the Internet web site for viewing by potential purchasers.

16. The method of claim 11, wherein posting information comprises disseminating information regarding the pre-owned integrated circuit manufacturing systems available for purchase to predetermined potential buyers.

17. The method of claim 11, wherein receiving an electronic purchase bid comprises receiving an electronic purchase bid having at least one condition of sale relating to technical services to be conducted on the specific pre-owned integrated circuit manufacturing system.

18. The method of claim 11, further comprising providing at least one payment and shipping option to a buyer of the specific pre-owned integrated circuit manufacturing system.

19. The method of claim 18, wherein the at least one payment option comprises at least one of an online escrow account, a cash on delivery arrangement, a credit arrangement, and a billable account.

20. The method of claim 11, further comprising receiving identification information from a buyer and the seller, wherein the identification information may be used to provide secure access to the Internet web site.
